(19) United States
(12) Patent Application Publication
(10) Pub. No.: US 2010/0205598 A1
(43) Pub. Date: Aug. 12, 2010

(54) METHOD FOR INSTALLING OPERATING SYSTEM IN COMPUTER

(75) Inventors: Ming-Yang Shao, Shanhai City (CN); Lai Kong, Shanhai City (CN); Jin Mao, Shanhai City (CN); Guo-Juan Xin, Shanhai City (CN); Eric Chiou, Taipei City (TW)

Correspondence Address: EDWARDS ANGELL PALMER & DODGE LLP, P.O. BOX 55874, BOSTON, MA, 02205, US

(73) Assignee: Inventec Corporation, Taipei City (TW)

(21) Appl. No.: 12/429,626

(22) Filed: Apr. 24, 2009

(30) Foreign Application Priority Data
Feb. 9, 2009 (TW) 098104023

(51) Int. Cl. G06F 9/445; G06F 15/177

(52) U.S. Cl. 717/174; 713/2

(57) ABSTRACT

The invention provides a method for installing an operating system in a computer having a plurality of hard disks. The method includes: establishing a BBS table in a fixed address space of a memory for recording a default boot sequence of the hard disks via a BIOS memory; setting the default boot sequence of the hard disks so as to form an actual boot sequence; and interchanging, in boot sequential order, a hard disk among the hard disks which have the highest boot priority in the default boot sequence and that of a hard disk having the highest boot priority in the actual boot sequence, such that the operating system is installed in the hard disk having the highest boot priority in the actual boot sequence, thereby improving the booting efficiency of the computer.

### BACKGROUND OF THE INVENTION

1. Field of the Invention

The present invention relates generally to a method for installing an operating system in a computer, and more particularly to a method for installing an operating system in a computer having a plurality of hard disks.

2. Description of Related Art

Personal computers have become the indispensable tools in human daily life. Different from a personal computer that serves only one user, a server receives job requests in a very short period of time and instantly makes responses and outputs data. Therefore, the computing ability of the server must be strong enough to process all computing jobs in a short time and provide processed information such that terminal computers connected to the server through a network can quickly obtain required data or results. Therefore, such a server has to be capable of adapting a large number of hard disks for accessing data.

When a computer is turned on, the Basic Input/Output System (BIOS) of the motherboard of the computer executes Power On Self Test (POST) first for checking all the internal equipments of the computer and the BIOS is used to control the operation of the basic hardware. After the POST is completed, the BIOS executes a boot program.

In general, the hard disks have an initial default boot sequence. The operating system of the computer is installed in a hard disk having the highest boot priority in the default boot sequence. If a user changes boot sequential order of the hard disk through a hardware or software, the hard disk installed with the operating system will not have the highest boot priority. Therefore, during the execution of the boot program, the BIOS must check whether the hard disks are installed with the operating system in accordance with the boot sequential order of the hard disk set by the user, thereby resulting in a poor booting efficiency of the computer.

Given the above, there is a need to provide a method for installing an operating system in a computer so as to overcome the above drawback.

### SUMMARY OF THE INVENTION

According to the above drawback, the present invention provides a method for installing an operating system in a computer having a plurality of hard disks. The method comprises the steps of: (1) providing a BIOS memory; (2) disposing a memory in the computer and defining a fixed address space in the memory; (3) establishing a BIOS Boot Specification table (BBS table) in the fixed address space of the memory through the BIOS memory for recording a default boot sequence of the hard disks; (4) forming an actual boot sequence of the hard disks; (5) interchanging one of the hard disks having a highest boot priority in the default boot sequence of the hard disks and one of the hard disks having a highest boot priority in the actual boot sequence of the hard disks in boot sequential order according to the actual boot sequence of the hard disks; and (6) installing the operating system in the one of the hard disks having the highest boot priority in the actual boot sequence of the hard disks.

The above-described method further comprises the step of providing a Complementary Metal Oxygen Semiconductor Random Access Memory (CMOS RAM), for the default boot sequence and the actual boot sequence of the hard disks to be stored in the CMOS RAM, and the hard disks individually to have corresponding CMOS values.

The interchanging step in the step (5) is preferably interchanging the corresponding CMOS value of the hard disk having the highest boot priority in the default boot sequence and that of the hard disk having the actual boot sequence.

The BIOS memory is preferably a BIOS Read Only Memory (ROM).

The address space is preferably a runtime segment.

According to the method for installing an operating system in a computer having the plurality of hard disks of the present invention, the operating system is installed in the hard disk having the highest boot priority in the actual boot sequence such that the computer can directly read the operating system of the hard disk, thereby improving the booting efficiency of the computer.

### BRIEF DESCRIPTION OF DRAWINGS

FIG. 1 is a flow diagram showing a method for installing an operating system in a computer according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

In the present embodiment, the method for installing an operating system in a computer according to the present invention is applied to a computer having a plurality of hard disks a, b, c and d. But it should be noted that the number of the hard disks is not limited to the present embodiment. In addition, the hard disks have a default boot sequence.

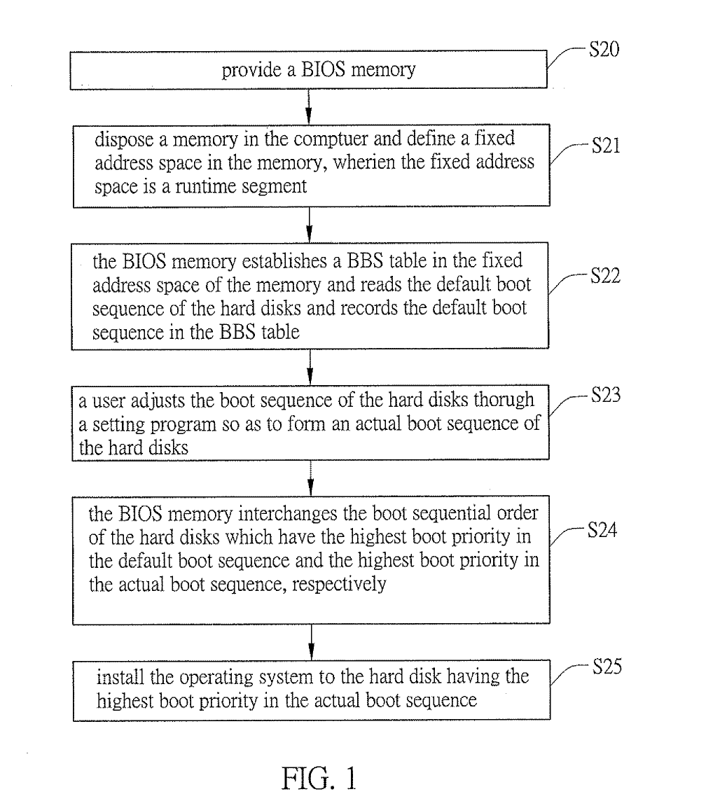

FIG. 1 is a flow diagram showing a method for installing an operating system in a computer according to the present invention. As shown in the drawing, the method comprises the following steps.

First, at step S20, a BIOS memory is provided, wherein the BIOS memory is a ROM. Then, the process goes to step S21.

At step S21, a memory is disposed in the computer and a fixed address space is defined in the memory by the computer, wherein the fixed address space is a runtime segment. Then, the process goes to step S22.

At step S22, the BIOS memory establishes a BIOS Boot Specification table (BBS table) in the fixed address space of the memory, and the BIOS memory reads the default boot sequence of the hard disks a, b, c and d, for example, the default boot sequence is 00, 01, 02 and 03, wherein 00 denotes the highest boot priority in the default boot sequence. The BIOS memory further records the default boot sequence in the BBS table. Then, the process goes to step S23.

At step S23, a user adjusts boot sequential order of the hard disks a, b, c or d through a setting program so as to form an actual boot sequence of the hard disks. For example, the actual boot sequence is 01, 00, 02 and 03, wherein 01 denotes that the hard disk b has the highest boot priority in the actual boot sequence. Preferably, the setting program runs through a setup utility interface provided in a BIOS. Then, the process goes to step S24.

At step 824, according to the actual boot sequence, the BIOS memory interchanges the boot sequential order of the hard disks a, b, each of which have the highest boot priority in the default boot sequence and the highest boot priority in the actual boot sequence. In particular, the computer further comprises a Complementary Metal-Oxide Semiconductor Random Access Memory (CMOS RAM) for storing the boot sequential order of the hard disks a, b, c and d. First, the default boot sequence 00, 01, 02, 03 of the hard disks is stored in the CMOS RAM and the hard disks have corresponding CMOS values, respectively. When the boot sequential order of the hard disk a having the highest boot priority in the default boot sequence is interchanged with the boot sequential order of the hard disk b having the highest boot priority in the actual boot sequence, a PnP (Plug and Play) program of the BIOS is used for interchanging the corresponding CMOS values of the hard disks a and b. At this time, the actual boot sequence 01, 00, 02, 03 of the hard disks is stored in the CMOS RAM. Then, the process goes to step S25.

At step S25, the operating system is installed to the hard disk b having the highest boot priority in the actual boot sequence.

Preferably, in the case the hard disk having the highest boot priority in the default boot sequence is the same as the hard disk having the highest boot priority in the actual boot sequence, the operating system writes boot information to the hard disk such that the operating system and the boot information are located on the same hard disk. Therein, the boot information is used for executing programs for booting up the computer.

Summarily, according to the method for installing an operating system in a computer of the present invention, a memory is disposed in the computer and a fixed address space is defined in the memory, a BIOS memory reads the default boot sequence of the hard disks from a CMOS RAM and records it to a BBS table in the fixed address space of the memory. Meanwhile, according to an actual boot sequence of the hard disks set by a user, the hard disk having the highest boot priority in the default boot sequence is interchanged in boot sequential order with the hard disk having the highest boot priority in the actual boot sequence and the corresponding CMOS values thereof are interchanged, thereby installing the operating system in the hard disk having the highest boot priority in the actual boot sequence. As a result, the booting efficiency of the computer is improved.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A method for installing an operating system in a computer having a plurality of hard disks, the method comprising the steps of:
(1) providing a BIOS memory;
(2) disposing a memory in the computer and defining a fixed address space in the memory;
(3) establishing a BIOS Boot Specification table in the fixed address space of the memory through the BIOS memory so as to record a default boot sequence of the hard disks;
(4) forming an actual boot sequence of the hard disks;
(5) interchanging one of the hard disks having a highest boot priority in the default boot sequence of the hard disks and one of the hard disks having a highest boot priority in the actual boot sequence of the hard disks in boot sequential order according to the actual boot sequence of the hard disks; and
(6) installing the operating system in the one of the hard disks having the highest boot priority in the actual boot sequence of the hard disks.

2. The method of claim 1, the step (4) further comprising providing a CMOS RAM, wherein the default boot sequence and the actual boot sequence of the hard disks are respectively stored in the CMOS RAM, and each the hard disks has a corresponding CMOS value individually.

3. The method of claim 2, wherein the interchanging of the step (5) is interchanging the corresponding CMOS value of the one of the hard disks having the highest boot priority in the default boot sequence and the corresponding CMOS value of the one of the hard disks having the highest boot priority in the actual boot sequence.

4. The method of claim 1, wherein the BIOS memory is a BIOS ROM.

5. The method of claim 1, wherein the fixed address space is a runtime segment.

6. The method of claim 1, wherein the forming the actual boot sequence of the hard disks is set by a user through a setup utility.

7. The method of claim 1, wherein the interchanging of the step (5) is performed through executing a Plug and Play program in the BIOS memory.

8. The method of claim 1, wherein if the one of the hard disks having the highest boot priority in the default boot sequence is the same as the one of the hard disks having the highest boot priority in the actual boot sequence, the operating system writes boot information to the one of the hard disks having the highest boot priority in the actual boot sequence such that the operating system and the boot information are located on a same hard disk.

9. The method of claim 8, wherein the boot information is used for executing programs for booting the computer.
